(19) United States
(12) Patent Application Publication
(10) Pub. No.: US 2015/0352013 A1
(43) Pub. Date: Dec. 10, 2015

(54) NEEDLE KIT

(71) Applicant: MEDI-PHYSICS, INC., Princeton, NJ (US)

(72) Inventor: Kevin M HELLE, Bartlett, IL (US)

(21) Appl. No.: 14/655,507

(22) PCT Filed: Dec. 26, 2013
(86) PCT No.: PCT/US2013/077803

§ 371 Date: Jun. 25, 2015

Related U.S. Application Data
(60) Provisional application No. 61/746,190, filed on Dec. 27, 2012.

(51) Int. Cl. A61J 1/20; B65B 3/00

(52) U.S. Cl. CPC A61J 1/201; A61J 1/2075; B65B 3/003

(57) ABSTRACT

Asceptic transfer through a needle penetrating a septum is accomplished by inserting an elongate inner tube through the needle and delivering a product fluid through the inner tube. Inner tube is desirably made from a polymer such as PTFE and product fluid does not contact the needle.

### FIELD OF THE INVENTION

The present invention relates to the field of fluid dispensing. More specifically, the present invention is directed to a needle kit for dispensing a product fluid.

### BACKGROUND OF THE INVENTION

The dispensement of pharmaceutical fluids into a final dispense container is typically performed in either of two ways. First, the fluid may be dispensed in an ‘open fill’ in which the fluid is directly dispensed into the open mouth of an un-stoppered container which is subsequently stoppered and terminally sterilized. Second, the fluid may be dispensed in a trans-septal fill in which the fluid is dispensed through the septum, or stopper, that has already been attached to or across the open mouth of the container. Trans-septal filling also offers the possibility of asceptic dispensing in that a previously-sterilized stopped container may be dispensed into without subsequent terminal sterilization, provided certain asceptic conditions are met before and during the filling process. Open fills can provide a dispense lumen, such as a blunt cannula or a blunt needle, in registry with the open mouth of the container. The open fill dispense lumen may be a simple blunt cannula as no piercing of a septum is required. However, open fills may be performed asceptically by maintaining the fill environment at an environmentally clean level, such as one meeting Class 100 standards, and by including a pair of sterilizing filters in the dispense flowpath before the dispense lumen. As shown in FIG. 1, trans-septal filling typically includes a device 10 including a block or fitting 12 supporting a sharpened fill needle 14 to be inserted through the septum of a dispense container so to provide the fluid to the dispense container and a sharpened vent needle 16 to be inserted through the septum to allow gas from the container to be displaced by the fluid. In both the open fill and trans-septal fill processes, the dispense cannula or fill needle are formed from metal. Prior to these metallic dispense cannulas or fill needles, the product fluid will typically flow through an elastomeric conduit as well as a fitting where the conduit is placed in fluid communication with the dispense cannula or needle.

The art lacks a dispense flowpath useful for either open fill or trans-septal fill that provides only a single material to contact the fluid through dispensing.

### SUMMARY OF THE INVENTION

The present invention provides a single concept which can satisfy the needs for an (1) an open fill, terminally sterilized, product, (2) a trans-septal fill, terminally sterilized, product, (3) an open fill, aseptic dispensed, product, and (4) a trans-septal fill, aseptic dispense, product. The aseptic applications may employ sterilizing filters on the dispense conduit of the present invention.

According to the present invention, for a trans-septal fill application, once a dispense needle or cannula reaches its final position prior to dispensing, with its distal tip extending through the septum of a product dispense container, an elongate inner tube is provided through the interior of needle or cannula so that one end of the distal end of inner tube extends to where it is even with or, desirably, beyond the distal end of the needle or cannula. The product fluid may then be directed through the inner tube and into the container, without contacting the material of the cannula or needle.

For open fill applications, the present invention contemplates that the inner tube may be directed through the cannula or needle at any time prior to dispensing the product fluid. That is, for open fill applications, the inner tube may be directed through the cannula or needle prior to the needle, carrying the tube with it, being positioned at a location at which filling may commence.

The present invention also provides devices for practicing the method of the present invention.

### BRIEF DESCRIPTION OF THE DRAWINGS

FIG. 1 depicts a prior art trans-septal fill system in which a product fluid contacts surfaces made of multiple materials.

FIG. 2 depicts a dispense system of the present invention as used in a terminal-sterilization open fill dispensing process.

FIG. 3 depicts the dispense system of FIG. 2 with the internal tube retracted into the cannula.

FIG. 4 depicts a dispense system of the present invention as used in an asceptic open fill dispensing process.

FIG. 5 depicts the dispense system of FIG. 4 with the internal tube retracted into the cannula.

FIG. 6 depicts a dispense system of the present invention as used in a trans-septal fill process.

FIG. 7 depicts the dispense system of FIG. 6 with the internal tube retracted into the cannula.

FIG. 8 depicts another dispense system of the present invention as used in a trans-septal fill process.

FIG. 9 depicts the dispense system of FIG. 8 with the internal tube retracted into the cannula.

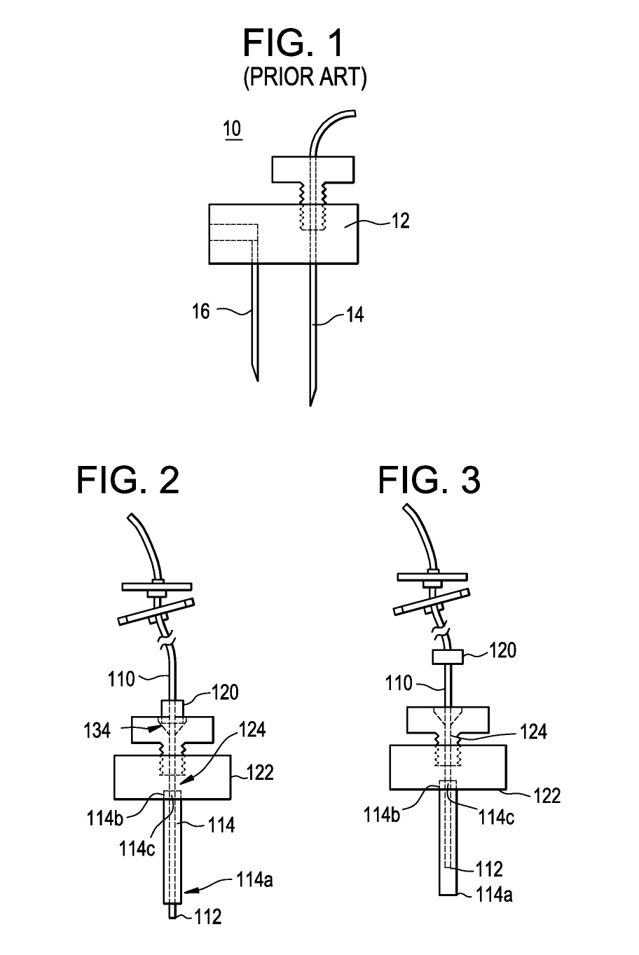

### DETAILED DESCRIPTION OF THE PREFERRED EMBODIMENTS

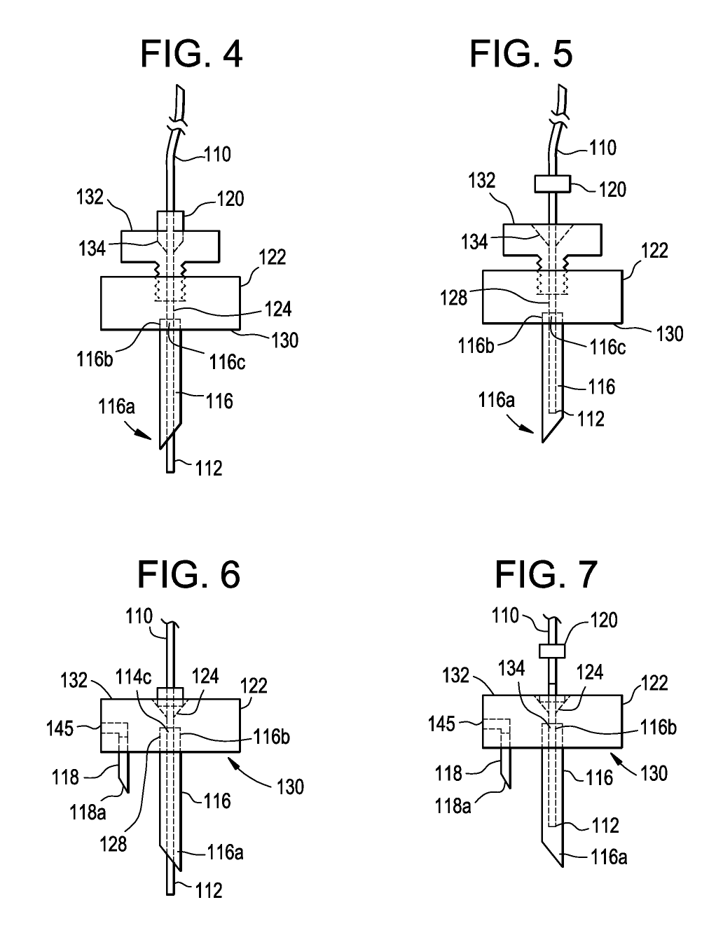

With reference to FIGS. 2-9, the present invention provides a method and devices for dispensing a product fluid so that the product fluid only contacts a single material throughout the dispensing operation. For trans-septal fill operations, the present invention provides an elongate polymeric conduit, or tube, 110 having a distal end 112 which is insertable through a dispense cannula 114 or needle 116 to extend to a position eve n with or past the distal end of the outer cannula 114a or needle 116a. The needle 116, intended to be inserted through a septum or stopper inserted into or across the mouth of the dispense container, typically includes a sharpened distal end 116a but may include a blunt distal end 116a as permitted by the design of the stopper. For open fill operations, the present invention provides an elongate polymeric conduit 110 having one end 112 which is insertable through a dispense cannula 114 or needle 116 to a position either in overlying registry with or within the open mouth of a container to be filled. The open fill needle may include a blunt distal tip 116a or may still include a sharpened distal tip 116a. By way of illustration and not of limitation, the elongate conduit of the present invention may be formed from a polymer such as, but not limited to, PTFE, although any suitable material for the fluid is contemplated for the present invention. Desirably, the conduit 110 of the present invention support a ferrule 120 about one segment thereof which will act as a positive stop for insertion of the conduit but which ensures that the distal end 112 of the conduit extends past the plane of the dispense opening of the cannula or needle. The present invention further contemplates that the plane of the dispense opening of the distal end of the conduit will extend past the most distal portion of the dispense cannula or needle.

The present invention may be employed in both open fill and trans-septal fill applications as well as in terminally sterilized or asceptic dispense operations. For open fill transfers, present invention contemplates positioning the dispense cannula 114 with its distal end 114a in registry with the open mouth of a dispense container. Alternatively, the distal end 114a of the dispense cannula 114 may be extended into the open mouth of the dispense container. In open fill transfers, the present invention provides for directing the polymeric conduit 110 of the present invention through the dispense cannula 114 to its dispense position either before, during, or after positioning of the dispense cannula in registry with or within the container mouth.

As shown in FIGS. 2-9, conduit 110 is movable from a first position (shown in FIGS. 3, 5, 7, 9) where its distal end 112 is positioned proximal the distal tip 114a or 116a of a cannula 114 or needle 116, respectively, to a second position (shown in FIGS. 2, 4, 6, 8) where distal end 112 of tube 110 extends even with or beyond distal tip 114a or 116a of cannula 114 or needle 116, respectively. The present invention further contemplates being able to retract tube 110 to the first position, such that tube 110 is movable between the first and second positions with respect to the cannula 114 or needle 116. The present invention then contemplates directing conduit 110 to a dispense position that is either co-extensive with the distal end 114a of the cannula 114 or that is beyond the distal end 114a of the cannula 114. The present invention further contemplates positioning a ferrule 120 about a portion of tube 110 and extending tube 110 through cannula 114 until ferrule 120 abuts a fitting 122 which supports the proximal end of 114b of cannula 114. The present invention also contemplates that other means for ensuring the proper positioning of tube 110 is employed such as, but not limited to, monitoring a spot on the outer surface of tube 110 or otherwise fixedly supporting tube 110 so as to travel with that support. Block, or fitting, 122 defines an elongate passageway 124 therethrough. Tube 110 is extended through passageway 124 and cannula 114 until ferrule 120 abuts block 122. Desirably, when ferrule 120 abuts either proximal end 114b of cannula 114 or block 122, distal end 112 of tube 110 will be in a dispense position that ensures no fluid dispensed from tube 110 will contact cannula 114.

For trans-septal transfers, the distal tip 116a of needle 116 is first extended through the septum or stopper placed within or across the mouth of the dispense container. The method then includes the step of pushing on block 122 to the septum, or to any position which ensures proper positioning of the distal tip 116a of needle 116 and distal tip 118a of vent needle 118. At this position, tube 110 may deliver fluid past tube end 112 into the container while vent needle 118 will allow gas to vent therethrough and out a vent passageway 145 defined by block 122. The method then includes the step of pushing on tube 110 or ferrule 120 so that tube end 112 now extends past the distal tip of needle 116. For both the open fill and trans-septal transfers, the present invention contemplates the provision of ferrule 120 positioned about the conduit 110 so as to be moved towards the dispense end 116a of needle 116, until it abuts against either the proximal end 116b of needle 116 or against a fitting 122 supporting needle 116.

The present invention contemplates that other methods or devices may be employed to limit the insertion of the conduit, such as, by way of illustration and not of limitation, an optical reader of an indicia on the outer surface of the conduit which provides for the generation of a stop signal to a device moving the conduit, abutment of a holding device which engages the conduit against a hard stop, or precise measurements so that an actuator only extends a fixed distance sufficient to move distal end 112 of the conduit 110 from a first position withdrawn from the distal end 114a or 116a of the cannula 114 or needle 116 to a second position where the distal end 112 of the conduit 110 extends even with or past the dispense opening defined by the distal end 114a or 116a of the cannula 114 or needle 116.

The present invention further contemplates that the proximal end of the conduit 110 may either extend to a bulk container of a fluid to be dispensed, or may connect to be placed in fluid communication with other devices used when dispensing the fluid. For example, the proximal end of the conduit may extend from the outlet port of a downstream valve of a dispense assembly such as is disclosed in Assignee's patent application “DUAL-FILTER DUAL-INTEGRITY TEST ASSEMBLY”, docket number PM1292P, filed at even date herewith.

The fittings 122 of the present invention desirably support a proximal end 114b or 116b of the dispense cannula 114 or needle 116 so as to be positioned within a recess 128 opening on a first face 130 of the fitting 122 opposite to a second face 132 of the fitting 122 from which the distal end of the cannula or needle depends. The recess 128 of fitting 122 desirably provides a tapering surface 134 extending from the second face 132 towards the proximal end 114b or 116b of the cannula 114 or needle 116. The tapering surface 134 is desirably a conical surface tapering towards the proximal end of the cannula so as to assist the insertion of the distal end 112 of conduit 110 through fitting 122, into the proximal opening 114c or 116c defined by the proximal end 114b or 116b of the cannula 114 or needle 116, respectively.

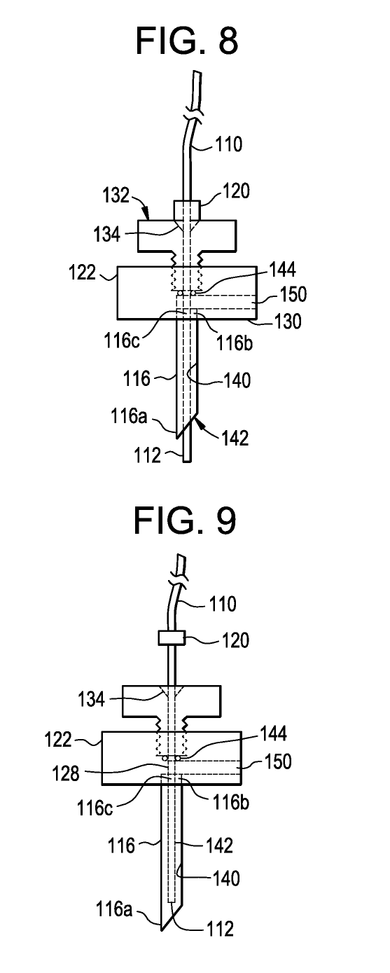

As shown in FIGS. 8 and 9, for asceptic transfer with only one spike or needle 116 through the septum, the present invention contemplates a method of running tube 110 through the ferrule 120, using the ferrule 120 to hold the tube in place so as to not transfer through anything except the PTFE/Teflon of the tube. The method then includes the step of pushing on the block to the septum (or to any position which ensures proper positioning of the distal tip 116a of needle 116), and then pushing on tube 110 or ferrule 120 so that tube end 112 now extends past the distal tip 116a of needle 116. Space 142 between tube 110 and the interior surface 140 of needle 116 allows venting out through open vent passage 150 defined by block 122. Vent passage 150 may be in direct fluid communication with recess 128 although it may be desirable to provide an elatomeric gasket 144 to seal a portion of recess 128 from vent passage 150 so as to further direct the outgassing.

With the dispense system, kits, and method of the present invention, a product fluid never sees any material other than the PTFE/tubing as it is dispensed into a dispense container, resulting in less chance of contamination of the product fluid.

While the present invention has been described as first moving a needle into place to a dispense position, the present invention alternatively contemplates that the present invention may be applied in a system which moves a container into position with a stationary dispense cannula or needle. In such a system, the septum or open mouth of the container could be pushed up to a block or fitting supporting the dispense cannula or needle, and then pushing both then pushing the container and fitting up until contact is made between the fitting and the ferrule about the conduit. Therefore, references to ‘moving’ or ‘positioning’ a cannula or needle of the present invention may include moving a dispense container so that the cannula or needle is in the dispense position. Alternatively still, the present invention contemplates that the after the container is moved into position, the conduit may then be moved to the dispense position until the ferrule contacts the fitting.

Additionally, the present invention provides a fitting for a dispense cannula or needle which also supports a venting needle so as to allow gas to vent from a container through the vent needle and out the fitting as the product fluid is introduced into the container. Additionally, still, while the present invention contemplates that the conduit will substantially conform in size and shape to the interior surface of the dispense cannula or needle, the present invention further contemplates that the conduit or needle may be over-sized as compared to the conduit so as to allow venting back through the additional space in the cannula or needle and out through a vent passage in the fitting which also communicates with the cannula or needle. With an over-sized cannula or needle, the present invention further contemplates that the cannula or needle wall defines a vent port some spaced distance from the dispense end of the cannula or needle through which the venting gas may flow as product fluid enters the dispense container.

The conduit of the present invention may be provided as a disposable member which is used to dispense the contents from a single bulk container. The disposable member may be provided as part of a kit with a conduit and a dispense cannula or needle which the conduit is adaptable to be inserted through in accordance with the present invention.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A method of dispensing a product fluid comprising the steps of:
a) Directing the distal open end of an elongate needle to be in registry with the mouth of a container,
b) Providing an elongate inner tube through the interior of said needle so that one end of said inner tube extends beyond the distal end of said needle;
c) Directing the product fluid through said inner tube into the container.

2. A method of claim 1, wherein said providing step further comprises the step of:
Moving the inner tube from a first position wherein said one end of said inner tube resides within said inner tube to a second position wherein said one end of said inner tube extends beyond the distal end of said needle.

3. A method of claim 2, wherein said inner tube includes a ferrule positioned thereabout such that at said second position, said ferrule abuts against a fitting of said needle.

4. A method of claim 1, wherein said inner tube is made of a polymer.

5. A method of claim 1, wherein said inner tube is made of PTFE.

6. A method of claim 2, wherein said fitting of said needle supports the proximal end of said needle.

7. A method of claim 6, wherein said fitting includes a fitting body defining opposed first openings, and an elongate needle passageway extending in fluid communication therebetween, said proximal end of said needle positioned adjacent to said first opening.

8. A method of claim 7, wherein said first opening of fitting is further defined by a conical surface tapering towards said proximal end of said needle.

9. A method of claim 8, wherein said proximal end of said needle is recessed within said fitting.

10. A method of claim 1, further comprising the step of directing the distal end of the needle through the mouth of the container.

11. A method of claim 10, further comprising the step of directing the distal end of the needle through a septum positioned across or within the mouth of the container such that the distal end of the needle extends beyond the septum.

12. A method of claim 11, wherein said distal end of said needle includes a sharpened point.

13. A method of claim 1, wherein said distal end of said needle is substantially blunt.

14. A needle kit for dispensing a product fluid comprising:
A first elongate needle having opposed proximal and distal ends and an elongate needle body extending therebetween, said proximal end defining a first aperture, said distal end defining a second aperture and said body defining an elongate passageway extending in fluid communication between said first and second openings;
A fitting supporting said proximal end of said first needle;
An elongate inner tube having opposed first and second ends and an elongate tubular wall extending therebetween, said first end defining an inlet port, said second end defining an outlet port and said wall defining an elongate fluidpath extending in fluid communication between said inlet port and said outlet port, said inner tube extendable between a first position wherein said second end does not extend through said passageway beyond said distal end of said first needle and a second position wherein said wall of said inner tube extends through said passageway such that said second end extends beyond said distal end of said first needle; and
A ferrule affixed about a portion of the outer surface of said wall, wherein said ferrule is sized and shaped to abut against one of said proximal end of said first needle and said fitting in said second position.

15. A needle kit of claim 14, further comprising:
A second needle supported by said fitting, said second needle including opposed proximal and distal ends and an elongate needle body extending therebetween, said proximal end defining a first aperture, said distal end defining a second aperture and said body defining an elongate passageway extending in fluid communication between said first and second openings.

16. A needle kit of claim 14, wherein said distal end of said second needle does not extend beyond said distal end of said first needle from said ferrule.

17. A needle kit of claim 14, wherein said inner tube is made of a polymer.

18. A needle kit of claim 14, wherein said inner tube is made of PTFE.

19. A needle kit of claim 14, wherein said fitting includes a fitting body defining opposed first openings, and an elongate needle passageway extending in fluid communication therebetween, said proximal end of said needle positioned adjacent to said first opening.

20. A needle kit of claim 19, wherein said first opening of fitting is further defined by a conical surface tapering towards said proximal end of said needle.

21. A needle kit of claim 20, wherein said proximal end of said needle is recessed within said fitting.

22. A needle kit of claim 14, wherein said distal end of said needle includes a sharpened point.

23. A needle kit of claim 14, wherein said distal end of said needle is substantially blunt.
